(19) United States
(12) Patent Application Publication
(10) Pub. No.: US 2017/0370225 A1
(43) Pub. Date: Dec. 28, 2017

(54) TURBOCHARGER

(71) Applicant: Honda Motor Co.,Ltd., Tokyo (JP)

(72) Inventors: Naoki ITOH, Saitama (JP); Naoki KUNO, Saitama (JP)

(73) Assignee: Honda Motor Co.,Ltd., Tokyo (JP)

(21) Appl. No.: 15/618,135

(22) Filed: Jun. 9, 2017

(30) Foreign Application Priority Data
Jun. 28, 2016 (JP) 2016-127724

(51) Int. Cl. F01D 5/04; F01D 25/24; F01D 25/00; F04D 17/10; F04D 29/02; F04D 29/58

(52) U.S. Cl. CPC F01D 5/046; F04D 29/023; F04D 29/5853; F01D 25/005; F04D 17/10; F01D 25/243; F05D 2220/40

(57) ABSTRACT

Provided is a turbocharger with further improved thermal efficiency. The turbocharger includes a heat shielding plate disposed between a center housing and a turbine housing. The center housing rotatably and pivotally supports a rotating shaft that connects a turbine impeller and a compressor impeller, and the turbine housing houses the turbine impeller. The turbocharger includes: a first flange portion; a second flange portion formed corresponding to the first flange portion; a clamp member combining the first flange portion and the second flange portion and fixing the mutual positional relationship; and a heat insulating ring interposed between an end surface, which is a heat shielding plate fixing portion that fixes the heat shielding plate, and the heat shielding plate on an inner peripheral side with respect to the first flange portion and the second flange portion.

### CROSS-REFERENCE TO RELATED APPLICATION

This application claims the priority benefit of Japan application serial no. 2016-127724, filed on Jun. 28, 2016. The entirety of the above-mentioned patent application is hereby incorporated by reference herein and made a part of this specification.

### BACKGROUND OF THE INVENTION

### Field of the Invention

The invention relates to a turbocharger adapted for an internal combustion engine, for example.

### Description of Related Art

A turbocharger adapted for an internal combustion engine is known, which is in a form having a heat shielding plate for suppressing transfer of heat from a turbine impeller to the side of a center housing (see Patent Literature 1, for example).

### PRIOR ART LITERATURE

### Patent Literature

### Patent Literature 1: Japanese Patent Publication No. 2015-127517

### SUMMARY OF THE INVENTION

### Problem to be Solved

In the turbocharger of Patent Literature 1, when the center housing and a turbine housing are fastened, the heat shielding plate is fixed with a flange portion, which is formed on the peripheral edge of the heat shielding plate, held between the center housing and the turbine housing. Thereby, the effect of suppressing leakage of the exhaust gas and the effect of shielding heat, brought by the heat shielding plate, can both be improved.

As a result of repeatedly conducting various tests and studies on the turbocharger of this type, the inventors have found that the heat transfer through the portion where the heat shielding plate is held between the center housing and the turbine housing reaches a degree that cannot be ignored. That is, due to the heat transfer through this portion, the enthalpy that should be directed to rotate the turbine impeller is released to the outside, resulting in reduction of the thermal efficiency of the turbocharger.

In view of the above-mentioned circumstances, the invention provides a turbocharger with further improved thermal efficiency.

### Solution to the Problem

(1) The turbocharger includes a heat shielding plate (e.g., the heat shielding plate 5 which will be described later) that is disposed between a center housing (e.g., the center housing 4 which will be described later) and a turbine housing (e.g., the turbine housing 2 which will be described later). The center housing rotatably and pivotally supports a rotating shaft (e.g., the rotating shaft 41 which will be described later) that connects a turbine impeller (e.g., the turbine impeller 21 which will be described later) and a compressor impeller (e.g., the compressor impeller 31 which will be described later), and the turbine housing houses the turbine impeller. The turbocharger includes: a first flange portion (e.g., the first flange portion 43a which will be described later) formed to protrude toward an outer periphery on an opposing end side of the center housing to the turbine housing; a second flange portion (e.g., the second flange portion 29a which will be described later) formed corresponding to the first flange portion on an opposing end side of the turbine housing to the center housing; a clamp member (e.g., the V band 50 which will be described later) combining the first flange portion and the second flange portion and fixing the mutual positional relationship; and a heat insulating ring (e.g., the heat insulating ring 6 which will be described later) interposed between a heat shielding plate fixing portion (e.g., the end surface 44a which will be described later), which fixes the heat shielding plate, and the heat shielding plate on an inner peripheral side with respect to the first flange portion and the second flange portion.

In the turbocharger of the above (1), the heat insulating ring is interposed between the heat shielding plate fixing portion, which fixes the heat shielding plate, and the heat shielding plate. Thus, the heat resistance in the heat transfer path, by which the heat from the side of the turbine housing is transferred to the side of the center housing, becomes sufficiently large to achieve effective heat shielding. Therefore, as the turbocharger, the thermal efficiency is improved.

(2) In the turbocharger of the above (1), the heat shielding plate fixing portion is set on the side of the opposing end (e.g., the end surface 44a which will be described later) of the center housing to the turbine housing.

In the turbocharger of the above (2), particularly when the form of fixing the heat shielding plate to a coupling end side of the center housing with the turbine housing is adopted in the turbocharger of the above (1), effective heat shielding is achieved between the turbine housing and the center housing, and as the turbocharger, the thermal efficiency is improved.

(3) In the turbocharger of the above (1) or (2), the heat insulating ring is made of ceramics (e.g., zirconia ceramics which will be described later).

In the turbocharger of the above (3), particularly, in the turbocharger of the above (1) or (2), the heat insulating ring is made of ceramics. Therefore, effective heat shielding is achieved, and as the turbocharger, the thermal efficiency is improved.

### Effects of the Invention

According to the invention, the turbocharger with further improved thermal efficiency can be realized.

### BRIEF DESCRIPTION OF THE DRAWINGS

FIG. 1 is a schematic cross-sectional view showing the turbocharger, in comparison with the conventional example, as an embodiment of the invention.

FIG. 2 is a cross-sectional view of the heat shielding plate of the turbocharger and the surroundings thereof as an embodiment of the invention.

FIG. 3 is a perspective view showing the turbocharger, when the turbine housing and the compressor housing are removed, as an embodiment of the invention.

FIG. 4 is a front view of the turbocharger of FIG. 3 as viewed from the side of the turbine impeller.

FIG. 5 is a schematic view showing how heat is transferred from the side of the turbine housing among main parts of the turbocharger of FIG. 2.

FIG. 6 is a cross-sectional view of the heat shielding plate of the conventional turbocharger and the surroundings thereof.

FIG. 7 is a schematic view showing how heat is transferred from the side of the turbine housing in the conventional turbocharger to be compared with FIG. 5.

### DESCRIPTION OF THE EMBODIMENTS

Embodiments of the invention are described in detail hereinafter with reference to the figures so as to clarify the invention. First, an overview of the whole configuration and operation of a turbocharger is described as an embodiment of the invention, and then a mounting structure of a heat shielding plate, which is a main part of the invention, is described in detail.

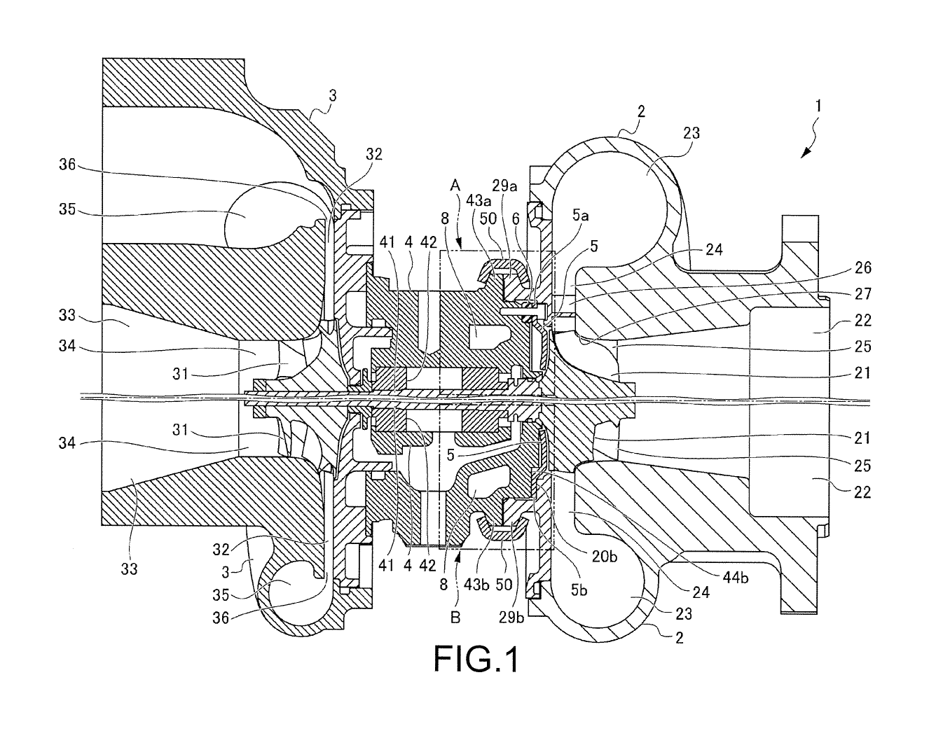

(Turbocharger as an embodiment of the invention) FIG. 1 is a schematic cross-sectional view showing the turbocharger, in comparison with a conventional example, as an embodiment of the invention. The upper half of a transverse one-dot chain line in the center of FIG. 1 is a cross-sectional view of the turbocharger according to an embodiment of the invention while the lower half of the one-dot chain line is a cross-sectional view of a turbocharger of the conventional example.

(Regarding the portions that the upper half and the lower half of the one-dot chain line in FIG. 1 have in common) Regarding the embodiment of the invention illustrated by the upper half of the transverse one-dot chain line in the center of the figure and the conventional example illustrated by the lower half of the one-dot chain line, the configuration of the portions suitable to be described collectively is described first.

An outer shell of a turbocharger 1 is composed of three housings, which include a turbine housing 2, a compressor housing 3, and a center housing 4 between the turbine housing 2 and the compressor housing 3. The turbine housing 2, the center housing 4, and the compressor housing 3 are combined in this order in a direction along a rotating shaft 41 in the center housing 4.
In the turbine housing 2, a turbine impeller 21 is provided, which rotates when receiving an exhaust gas from an internal combustion engine (not shown).
In the compressor housing 3, a compressor impeller 31 is provided, which is coupled to the turbine impeller 21 via the rotating shaft 41 and rotates to compress an intake air to the internal combustion engine.
The rotating shaft 41 is a rod-shaped shaft connecting the turbine impeller 21 and the compressor impeller 31 and is supported by a bearing 42 in the center housing 4.
The turbine housing 2 has a scroll flow passage 23, which is arranged around an outer periphery of the turbine impeller 21, between an exhaust gas intake portion (not shown), which serves as an exhaust gas inlet, and a discharge portion 22, which serves as an outlet. The scroll flow passage 23 is formed with an exhaust gas flow passage 24, which serves as a gas inlet passage communicating with the turbine impeller 21.

The scroll flow passage 23 in this embodiment is arranged to go around the outer periphery of the turbine impeller 21 as described above and is formed as a single gas circulation passage with no additional partition walls, etc., inside.

The turbine impeller 21 is disposed in a tubular turbine impeller chamber 25 formed to be surrounded by the scroll flow passage 23, and is provided with the annular exhaust gas flow passage 24 that communicates the scroll flow passage 23 and a base end side of the turbine impeller chamber 25. In the exhaust gas flow passage 24, a plurality of blade-shaped nozzle vanes 26 are disposed at equal intervals along a circumferential direction of the rotating shaft 41 and at predetermined angles with respect to the circumferential direction, so as to surround the base end side of the turbine impeller chamber 25. Moreover, a portion near the outlet of the nozzle vanes 26 forms a shroud portion 27. The exhaust gas flow passage 24 and the nozzle vanes 26 constitute an exhaust gas supply portion for supplying the exhaust gas as a working fluid to the turbine impeller 21. In addition, it is not necessary to dispose the nozzle vanes. A form without such nozzle vanes is depicted on the lower side of the one-dot chain line in FIG. 1.

In the compressor housing 3, the compressor impeller 31 and a diffuser 32 are provided.

The compressor housing 3 is formed with a tubular compressor impeller chamber 34 in which an intake air intake portion 33 connected to an intake air pipe (not shown) of the internal combustion engine is formed on a distal end side of the compressor housing 3, an annular scroll flow passage 35 which is formed to surround the compressor impeller chamber 34, and an annular intake air flow passage 36 which communicates a base end side of the compressor impeller chamber 34 with the scroll flow passage 35.

The compressor impeller 31 is rotatably disposed in the compressor impeller chamber 34 in a state of being connected to the other end side of the rotating shaft 41. The diffuser 32 is disk-shaped and is disposed in the intake air flow passage 36. The diffuser 32 decelerates the intake air discharged from the base end side of the compressor impeller chamber 34 toward the scroll flow passage 35 along a centrifugal direction of the rotating shaft 41, so as to compress the intake air.

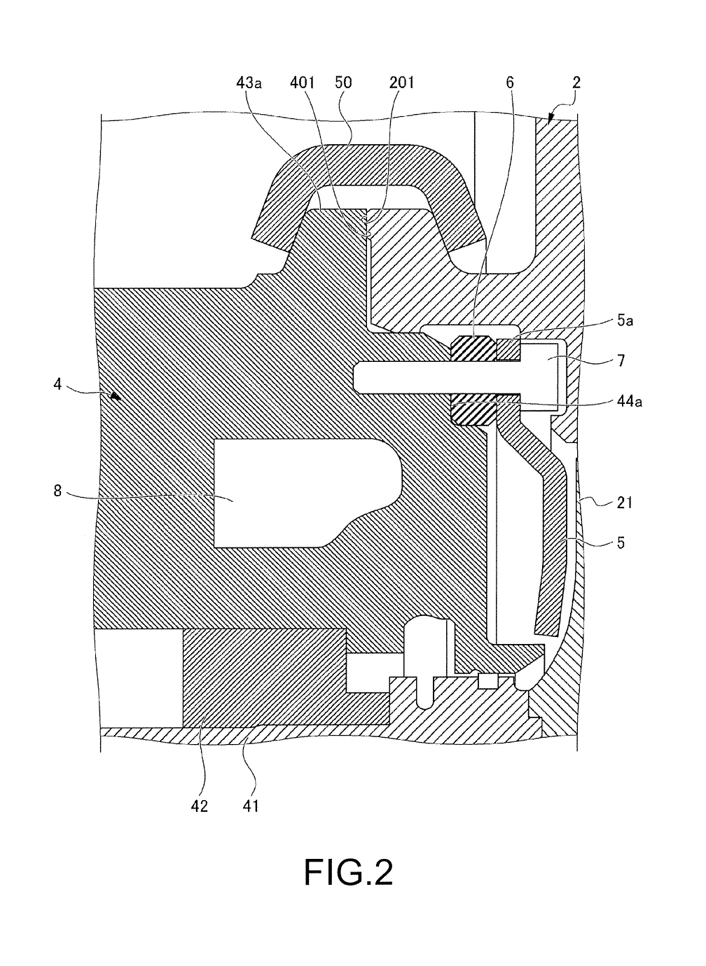

(Regarding the portion of a virtual area A in the upper half of the one-dot chain line in FIG. 1) Next, the configuration of an embodiment of the invention depicted in the portion of the virtual area A (indicated by a two-dot chain line) in the upper half of the transverse one-dot chain line in the center of FIG. 1 is described also with reference to FIG. 2.

FIG. 2 is an enlarged view of the virtual area A in FIG. 1, and is a cross-sectional view of a heat shielding plate of the turbocharger and the surroundings thereof as an embodiment of the invention.
A first flange portion 43a is formed around a coupling end side of the center housing 4 with the turbine housing 2.
A second flange portion 29a corresponding to the first flange portion 43a is formed on a coupling end side of the turbine housing 2 with the center housing 4, wherein the turbine housing 2 houses the turbine impeller 21.
Further, a V band 50 is disposed to serve as a clamp member that combines the first flange portion 43a and the second flange portion 29a to fix the mutual positional relationship.

An opposing portion of the center housing 4 to the turbine housing 2 is formed with a small diameter to form a step from the aforementioned first flange portion 43a and is fitted to an inner diameter side of the aforementioned second flange portion 29a of the turbine housing 2. The heat shielding plate 5 is attached to an end surface 44a that is partially substantially annular and is flattened in the vicinity of a peripheral edge of an end of the center housing 4 fitted to the inner diameter side of the second flange portion 29a as described above. More specifically, the heat shielding plate 5 is a substantially disk-shaped metal plate that has a hole in the center, and a heat shielding plate flange portion 5a on an outer peripheral side is attached to the end surface 44a of the center housing 4 by a bolt 7 via an annular heat insulating ring 6. A cooling water passage 8 is disposed around the bearing 42 that pivotally supports the rotating shaft 41.

Here, preferably the heat shielding plate 5 is a material having a low thermal conductivity, and is austenitic stainless steel such as SUS310, for example. Moreover, preferably the heat insulating ring 6 is a material having a low thermal conductivity, and is zirconia ceramics, etc., for example.

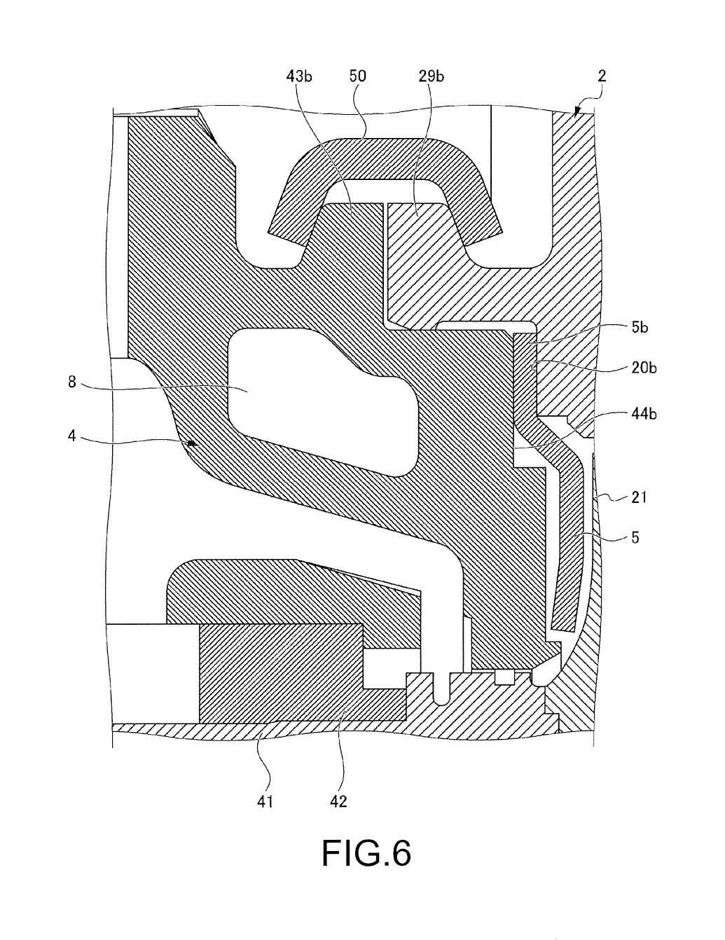

(Regarding the portion of a virtual area B in the lower half of the one-dot chain line in FIG. 1) Next, the configuration of an embodiment of the invention depicted in the portion of the virtual area B (indicated by a two-dot chain line) in the lower half of the transverse one-dot chain line in the center of FIG. 1 is described also with reference to FIG. 6.

FIG. 6 is an enlarged view of the virtual area B in FIG. 1, and is a cross-sectional view of a heat shielding plate of the conventional turbocharger and the surroundings thereof. In addition, to make it easy for comparison with the embodiment of the invention later, FIG. 6 depicts the portion B in FIG. 1 by reversing it to the upper side with respect to the axis of the one-dot chain line.
A first flange portion 43b is formed around a coupling end side of the center housing 4 with the turbine housing 2.
A second flange portion 29b corresponding to the first flange portion 43b is formed on a coupling end side of the turbine housing 2 with the center housing 4, wherein the turbine housing 2 houses the turbine impeller 21.
Further, a V band 50 is disposed to serve as a clamp member that combines the first flange portion 43b and the second flange portion 29b to fix the mutual positional relationship.

An opposing portion of the center housing 4 to the turbine housing 2 is formed with a small diameter to form a step from the aforementioned first flange portion 43b and is fitted to an inner diameter side of the aforementioned second flange portion 29b of the turbine housing 2. The heat shielding plate 5 is held between an end surface 44b and an opposing surface 20b of the turbine housing 2 to be fixed, wherein the end surface 44b is substantially annular and is flattened in the vicinity of a peripheral edge of an end of the center housing 4 fitted to the inner diameter side of the second flange portion 29b as described above, and the opposing surface 20b of the turbine housing 2 is opposed to the end surface 44b. More specifically, a heat shielding plate flange portion 5b on an outer peripheral side of the heat shielding plate 5 is directly held between the end surface 44b on the side of the center housing 4 and the opposing surface 20b on the side of the turbine housing 2, so as to fix the heat shielding plate 5.

A cooling water passage 8 is disposed around the bearing 42 that pivotally supports the rotating shaft 41.

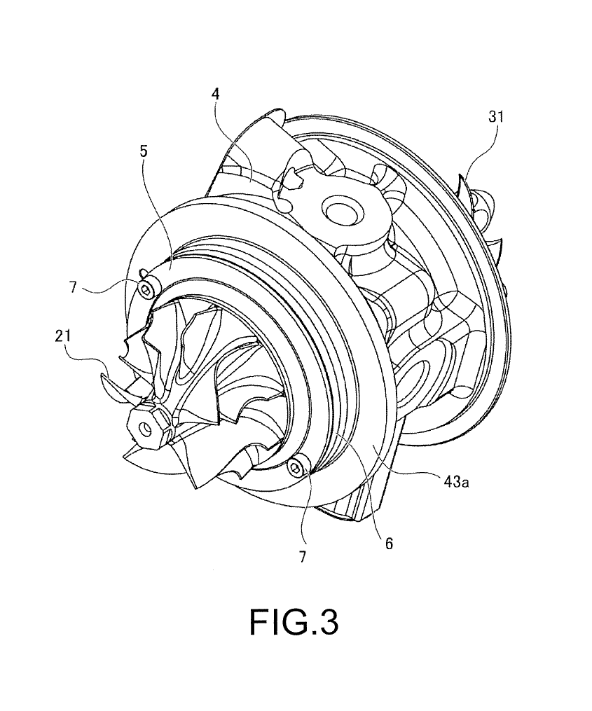

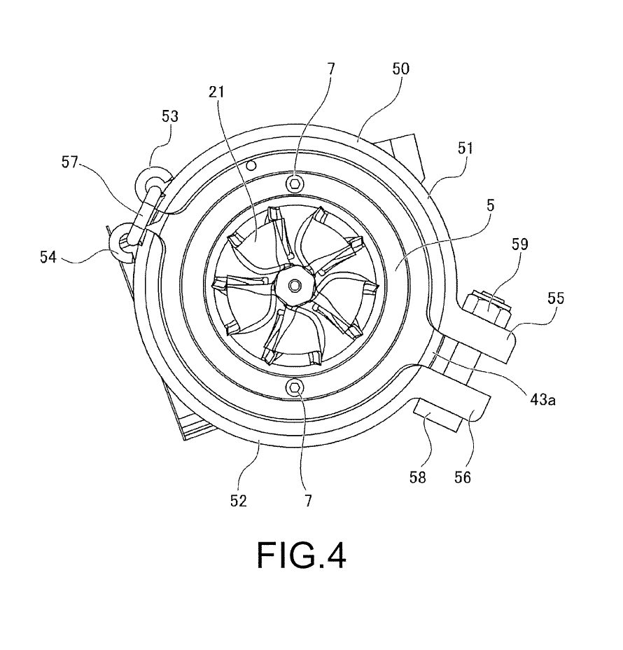

(The turbine impeller, the heat shielding plate, the heat insulating ring, and the peripheral portions thereof in FIG. 1) The turbine impeller, the heat shielding plate, the heat insulating ring, and the peripheral portions thereof in FIG. 1 are described with reference to FIG. 3 and FIG. 4.

FIG. 3 is a perspective view showing the turbocharger, when the turbine housing and the compressor housing are removed, as an embodiment of the invention.
In FIG. 3, portions corresponding to those in FIG. 1 are assigned with the same reference numerals.
In FIG. 3, on the near side of the figure of the center housing 4 in the center, in the state where the turbine housing 2 is removed, the turbine impeller 21 is exposed. On the rear in an axial direction of the turbine impeller 21, the heat shielding plate 5 as described above with reference to FIG. 1 and FIG. 2 is fastened to the aforementioned end surface (cannot be seen in FIG. 3) of the center housing 4 via the heat insulating ring 6 by two bolts 7 at positions separated 180 degrees in the circumferential direction.
In addition, on the rear of the figure of the center housing 4, in the state where the compressor housing 3 is removed, the compressor impeller 31 is exposed.

FIG. 4 is a front view of the turbocharger of FIG. 3 as viewed from the side of the turbine impeller.

In FIG. 4, the turbine housing 2 has been removed, but to facilitate the explanation, FIG. 4 depicts a state where the V band 50 as described above with reference to FIG. 1 and FIG. 2 is attached.
In FIG. 4, portions corresponding to those in FIG. 3 are assigned with the same reference numerals.
In FIG. 4, the state where the heat shielding plate 5 is attached by two bolts 7 at positions separated by 180 degrees in the circumferential direction is visually recognized.
In FIG. 4, the V band 50 wound around the outer periphery of the center housing 4 (cannot be seen in FIG. 4) forms an arc shape by combining one half arc portion 51 and the other half arc portion 52 corresponding thereto, and combines the aforementioned first flange portion 43a of the center housing 4 and the second flange portion 29a of the turbine housing 2 (cannot be seen in FIG. 4) to fix the mutual positional relationship. More specifically, a folded portion 53 is formed on one end side of the half arc portion 51 and likewise a folded portion 54 is formed on one end side of the half arc portion 52. Moreover, a flange portion 55 is formed on the other end side of the half arc portion 51 and likewise a flange portion 56 is formed on the other end side of the half arc portion 52. The folded portions 53 and 54 are joined together by an annular member 57 that is common to the folded portions 53 and 54, and furthermore, the flange portions 55 and 56 are fastened by a bolt 58 and a nut 59. By properly tightening the nut 59, the V band 50 combines the aforementioned first flange portion 43a of the center housing 4 and the second flange portion 29a of the turbine housing 2 and firmly secures the mutual positional relationship with an appropriate pressing force.

(Operation of the turbocharger of this embodiment) The turbocharger 1 configured as described above operates as follows and supercharges the intake air by using the energy of the exhaust gas of the internal combustion engine.

First, an overview of the operation of the turbocharger 1 is described with reference to FIG. 1. The exhaust gas of the internal combustion engine is introduced from the exhaust gas intake portion (not shown) into the scroll flow passage 23. The exhaust gas that is swirled as it passes through the scroll flow passage 23 flows into the base end side of the turbine impeller chamber 25 at an angle determined by the nozzle vanes 26 and rotates the turbine impeller 21 to be discharged from the discharge portion 22 on the downstream side of the turbine impeller chamber 25. The rotation of the turbine impeller 21 is transmitted to the compressor impeller 31 via the rotating shaft 41, and the compressor impeller 31 rotates in the compressor impeller chamber 34. The intake air introduced into the compressor impeller chamber 34 via the intake air intake portion 33 due to rotation of the compressor impeller 31 is discharged from the base end side of the compressor impeller 31 toward the scroll flow passage 35 along the centrifugal direction. The intake air discharged from the compressor impeller 31 is decelerated as it is spread by the diffuser 32, and the static pressure rises as the dynamic pressure drops. At this time, the total pressure decreases by an amount corresponding to the loss caused by the diffuser 32. The intake air that is decelerated and has the rising static pressure flows through the scroll flow passage 35 and is introduced into an intake air port of the internal combustion engine (not shown).

(Regarding transfer of heat in the turbocharger of this embodiment) The invention was made based on a new finding which is about a phenomenon that the inventors discovered through tests and studies on heat transfer in the turbocharger having the heat shielding plate. This is a point that should be particularly noted regarding the invention.

That is, in order to confirm the heat transfer path including the periphery of the heat shielding plate, the inventors have repeatedly performed heat transfer analyses on the turbocharger main body. As a result, first, it was found that the flow of heat consumption can be roughly divided into the following four flows:
(1) consumption caused by rotating the turbine;
(2) consumption that becomes an exhaust component without being used;
(3) consumption caused by heat radiation from the main body; and
(4) consumption caused by transmission to the center housing and transmission to the lubricating oil and cooling water.

The quantitative evaluation results are roughly as follows.

The above (1) refers to consumption of heat used for the original work, and this heat amount is represented by (a).
The above (2) refers to consumption of heat that is released to the atmosphere mainly from the scroll flow passage and is intended to be used for the work but the enthalpy is released to the outside, and this heat amount is represented by (b).
The above (3) refers to consumption of heat that is transmitted and released to the turbine impeller, and this heat amount is represented by (c).
The above (4) refers to consumption of heat that is transmitted from the turbine housing to the center housing and cooled, and this heat amount is represented by (d).
According to the analysis results obtained by the inventors, with the maximum rotation speed set to 100, when the turbine rotation speed was 60% to 80% of the maximum rotation speed, (a) was ensured to be about 75% to about 87%, whereas (b) was about 12% to about 6%, (c) was less than 1%, and (d) was about 13% to about 7%.
Based on their finding as described above, the inventors realized that by reexamining the structure of the center housing fastening portion from the turbine housing, the heat loss of the flow of the above (4), that is, the value of (d), can be significantly reduced to eventually greatly improve the efficiency of the turbocharger.

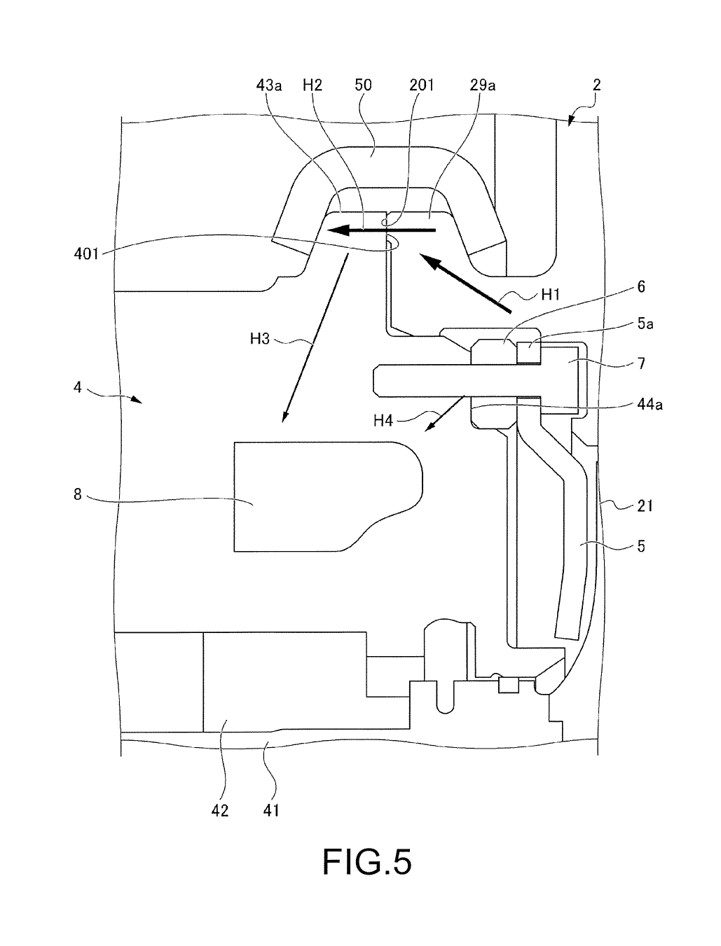

FIG. 5 is a schematic view showing how heat is transferred from the side of the turbine housing among main parts of the turbocharger of FIG. 2.

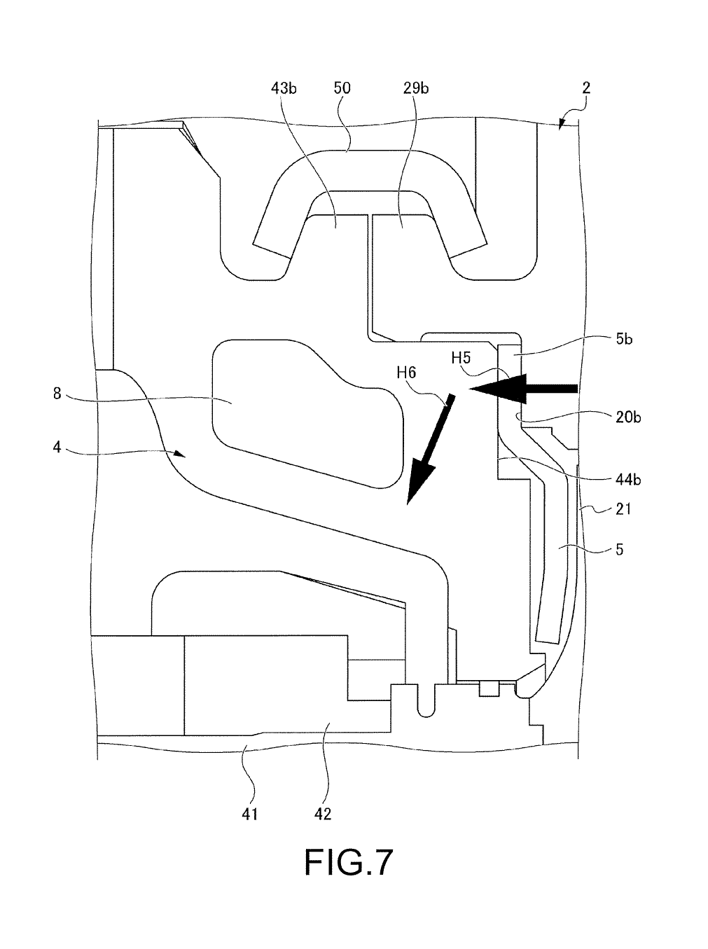

FIG. 7 is a schematic view showing how heat is transferred from the side of the turbine housing in the conventional turbocharger to be compared with FIG. 5.
In FIG. 5, portions corresponding to those of FIG. 2 that have been described are assigned with the same reference numerals, and the description of these portions is omitted where appropriate.
Moreover, in FIG. 7, portions corresponding to those of FIG. 6 that have been described are assigned with the same reference numerals, and the description of these portions is omitted where appropriate.
In FIG. 5 and FIG. 7, the line thickness of the arrow indicates the heat transfer amount (a reciprocal of heat resistance), and the length of the arrow indicates the distance of heat transfer. The heat transfer amount (the amount of heat passing through a surface in a unit time, and the unit is W) increases as the heat resistance decreases. That is, the reciprocal of the heat resistance is proportional to the heat transfer amount.

In the embodiment of FIG. 5, as indicated by the arrow H1, the heat from the side of the turbine housing 2, which stores the turbine impeller 21, is transferred with a relatively large heat transfer amount toward a contact portion between a contact end surface 201 on the side of the second flange portion 29a and a contact end surface 401 on the side of the first flange portion 43a. Further, as indicated by the arrow H2, the heat with a relatively large heat transfer amount is transferred to the side of the first flange portion 43a of the center housing 4 through the contact portion between the contact end surface 201 and the contact end surface 401. Regarding the arrow H2, the heat is transferred with a relatively large heat transfer amount, as described above, because in this embodiment, the contact end surface 201 on the side of the second flange portion 29a and the contact end surface 401 on the side of the first flange portion 43a are put in contact with each other by a large surface pressure due to the clamping force of the V band 50.

The heat transferred to the side of the first flange portion 43a, as indicated by the arrow H2, is then transferred a relatively long distance with a relatively small heat transfer amount, as indicated by the arrow H3, to be transferred to the cooling water passage 8 of the center housing 4. In the heat transfer path of the arrow H1→the arrow H2→the arrow H3→the cooling water passage 8, as described above, the heat is transferred from the heat shielding plate 5 by a relatively long distance to detour along the side of the peripheral flange portions (the second flange portion 29a and the first flange portion 43a), and in this heat transfer path, the heat transfer amount as a whole does not become much larger. In other words, the heat resistance is relatively large in this heat transfer path.

On the other hand, at the portion where the heat shielding plate 5 is attached to the aforementioned end surface 44a of the center housing 4 by the bolt 7, the heat insulating ring 6 is interposed between the heat shielding plate 5 (the heat shielding plate flange portion 5a thereof) and the center housing 4 (the end surface 44a, which is the heat shielding plate fixing portion thereof). Therefore, the heat transferred from the heat shielding plate 5 to the center housing 4 through the end surface 44a has a relatively small heat transfer amount, as indicated by the arrow H4. In the heat transfer path indicated by the arrow H4, if the heat transfer area of the portion of the end surface 44a is set as 100, 96.5% is transferred to the center housing 4 through the heat shielding plate 5 and the heat insulating ring 6. In other words, the heat resistance is relatively large in the heat transfer path, as indicated by the arrow H4.

As described above, in the case where the heat insulating ring 6 is made of ceramics (zirconia ceramics) which is a material having a low thermal conductivity, it shows particularly large heat resistance.
Moreover, in this embodiment, as described with reference to FIG. 3 and FIG. 4, the heat shielding plate 5 is fastened to the end surface 44a of the center housing 4 via the heat insulating ring 6 by two bolts 7 at positions separated by 180 degrees in the circumferential direction. Accordingly, the heat transfer amount through this portion is reduced, as compared with a case where the heat shielding plate 5 is fastened to the end surface 44a at more positions.

In contrast to the case of FIG. 5 described above, in the conventional turbocharger of FIG. 7, the heat from the side of the turbine housing 2, which stores the turbine impeller 21, is transferred with a very large heat transfer amount through the portion where the heat shielding plate 5 is held between the turbine housing 2 and the center housing 4, as indicated by the arrow H5.

More specifically, the heat shielding plate flange portion 5b on the outer peripheral side of the heat shielding plate 5 is directly held between the end surface 44b on the side of the center housing 4 and the opposing surface 20b on the side of the turbine housing 2 by a large pressing force, so as to fix the heat shielding plate 5. Therefore, at the portion where the heat shielding plate 5 (the heat shielding plate flange portion 5b) is held, the heat resistance is small and a very large heat transfer amount is transferred easily, as indicated by the arrow H5. The heat transferred as indicated by the arrow H5 is transferred toward the cooling water passage 8, which is located at a relatively short distance from the portion where the heat shielding plate flange portion 5b is held, as indicated by the arrow H6, with a large heat transfer amount.

That is, in the heat transfer path of the arrow H5→the arrow H6→the cooling water passage 8 in FIG. 7, the heat is transferred by a relatively short distance, and in this heat transfer path, the heat transfer amount as a whole is very large compared to that of FIG. 5. In other words, the heat resistance is relatively small in this heat transfer path. According to the above, as can be easily understood from the description with reference to FIG. 5 and FIG. 7, in this embodiment of FIG. 5, as compared with the conventional technique of FIG. 7, the heat flow of the aforementioned (4), that is, the heat consumption due to transmission to the center housing and transmission to the lubricating oil and the cooling water is suppressed significantly. Generally, a phenomenon called “heat soak back” may occur on a turbo machine, which refers to that heat is not released and is stored for a relatively long time even after stoppage, and it may cause thermal damage to the bearing unit of the rotating shaft. In order to prevent such thermal damage, a certain amount of cooling water circulates constantly in the cooling water passage. Thus, as in this embodiment, the large heat resistance of the heat transfer path to the cooling water passage is effective in preventing unnecessary cooling and suppressing heat loss.

Accordingly, in this embodiment, the turbocharger with very high thermal efficiency is realized.

Further, in this embodiment, the contact surface between the turbine housing 2 and the center housing 4 is disposed on the side of the flange portions (the second flange portion 29a and the first flange portion 43a), which is at the position protruding toward the outer periphery of the center housing 4. That is, the contact portion between the contact end surface 201 on the side of the turbine housing 2 and the contact end surface 401 on the side of the center housing 4 is farther on the outer diameter side than the conventional example (that is, the aforementioned contact between the opposing surface 20b and the end surface 44b). Therefore, the temperature is relatively low at this contact portion, and strength against the high surface pressure at the high temperature portion is not required, and it is possible to use relatively inexpensive materials and reduce the wall thickness of the parts.

Furthermore, by using such a contact portion as a gas sealing surface, the gas sealing surface can be formed in a lower temperature range than the conventional art, so it is possible to select a relatively high surface pressure within the range of the material strength, and as a result, improvement of the sealing performance can be expected.

Effects of the operation of the turbocharger according to the embodiment described above are summarized below.

(1) The turbocharger 1 includes the heat shielding plate 5 that is disposed between the center housing 4 and the turbine housing 2. The center housing 4 rotatably and pivotally supports the rotating shaft 41 that connects the turbine impeller 21 and the compressor impeller 31, and the turbine housing 2 houses the turbine impeller 21. The turbocharger 1 includes: the first flange portion 43a formed to protrude toward the outer periphery on the opposing end side of the center housing 4 to the turbine housing 2; the second flange portion 29a formed corresponding to the first flange portion 43a on the opposing end side of the turbine housing 2 to the center housing 4; the V band 50 combining the first flange portion 43a and the second flange portion 29a and fixing the mutual positional relationship; and the heat insulating ring 6 interposed between the end surface 44a, which is the heat shielding plate fixing portion that fixes the heat shielding plate 5, and the heat shielding plate 5 on the inner peripheral side with respect to the first flange portion 43a and the second flange portion 29a.

In this way, since the heat insulating ring is interposed between the end surface 44a, which is the heat shielding plate fixing portion that fixes the heat shielding plate 5, and the heat shielding plate 5, the heat resistance in the heat transfer path (particularly, H4 in FIG. 4), by which the heat from the side of the turbine housing 2 is transferred to the side of the center housing 4, becomes sufficiently large to achieve effective heat shielding. Therefore, as the turbocharger, the thermal efficiency is improved.

(2) In the turbocharger 1, particularly the following form is adopted: the end surface 44a, which is the heat shielding plate fixing portion, is set on the side of the end surface 44a, which is the opposing end of the center housing 4 to the turbine housing 2. When this form is adopted, with the aforementioned configuration, effective heat shielding is achieved between the turbine housing 2 and the center housing 4, and as the turbocharger, the thermal efficiency is improved.

(3) In the turbocharger 1, particularly the heat insulating ring 6 is made of ceramics (zirconia ceramics). Therefore, effective heat shielding is achieved, and as the turbocharger, the thermal efficiency is improved.

In addition to the embodiments described above, the scope of the invention may cover various variations or modifications without departing from the spirit of the invention.

For example, in the turbocharger of the invention, the heat shielding plate fixing portion that fixes the heat shielding plate 5 is set on the end surface 44a on the side of the center housing 4. However, the heat shielding plate fixing portion is not limited thereto, and may also be set at an appropriate position on the side of the turbine housing 2, for example.

What is claimed is:

1. A turbocharger comprising a heat shielding plate disposed between a center housing and a turbine housing, wherein the center housing rotatably and pivotally supports a rotating shaft that connects a turbine impeller and a compressor impeller, and the turbine housing houses the turbine impeller, the turbocharger comprising:
a first flange portion formed to protrude toward an outer periphery on an opposing end side of the center housing to the turbine housing;
a second flange portion formed corresponding to the first ange portion on an opposing end side of the turbine housing to the center housing;
a clamp member combining the first flange portion and the second flange portion and fixing a mutual positional relationship; and
a heat insulating ring interposed between a heat shielding plate fixing portion that fixes the heat shielding plate and the heat shielding plate on an inner peripheral side with respect to the first flange portion and the second flange portion.

2. The turbocharger according to claim 1, wherein the heat shielding plate fixing portion is set on the opposing end side of the center housing to the turbine housing.

3. The turbocharger according to claim 1, wherein the heat insulating ring is made of ceramics.

4. The turbocharger according to claim 2, wherein the heat insulating ring is made of ceramics.
